(19) United States
(12) Patent Application Publication
(10) Pub. No.: US 2009/0270209 A1
(43) Pub. Date: Oct. 29, 2009

(54) Gear assembly and constinuously variable transmission comprising gear assembly

(76) Inventor: Gunnar Lindkvist, Farila (SE)

Correspondence Address: DOWELL & DOWELL P.C., 103 Oronoco St., Suite 220, Alexandria, VA, 22314, US

(21) Appl. No.: 11/991,417

(22) PCT Filed: Sep. 28, 2006
(86) PCT No.: PCT/SE2006/001099

§ 371 Date: Sep. 11, 2008

Related U.S. Application Data
(60) Provisional application No. 60/721,572, filed on Sep. 29, 2005.

(30) Foreign Application Priority Data
Sep. 30, 2005 (SE) 0502148-0

(51) Int. Cl. F16H 55/56; F16H 9/20

(52) U.S. Cl. 474/30; 474/8

(57) ABSTRACT

The present invention concerns a gear assembly, suitable for a continuously variable transmission, comprising two gear tooth devices (10, 50) making up an imaginary gear wheel with variable pitch diameter, the two gear tooth devices being radially movable and also a continuously variable transmission comprising an input shaft (1), an output shaft (2), a gear-changing shaft (3) and first gearbox shaft (4) comprising a gear assembly according to the invention, a transmission chain (5) and a second gearbox shaft (6) comprising a gear assembly according to the invention or a gear wheel (7), whereby the first gearbox shaft (4) is driven by the input shaft (1), the second gearbox shaft (6) or the gear wheel (7) is driven by the first gearbox shaft (4), and the output shaft (2) is driven by the second gearbox shaft (6) or the gear wheel (7).

The present invention concerns a gear assembly and also continuously variable transmissions comprising such a gear assembly.

The gearboxes are today the aim of the work of the vehicle industry for decreasing the fuel consumption in vehicles. A traditional automatic gearbox of today consumes around 10% more energy than a manual gearbox. Increased environmental demands and increasing fuel costs forces the vehicle industry to find new solutions for the future.

Previously known there are continuously variable transmissions (CVT), which make it possible to continuously change the gear ratio without any steps, i.e. it has an infinite number of gear ratios between a minimum and a maximum value. This makes it possible for the engine to operate at its optimum rpm independent of the speed of the vehicle.

There are three main types of CVTs, namely friction type, hydrostatic type and ratcheting type. Cf, for example, the Variomatic and Multitronic CVTs. A main problem with CVTs is that there is a considerable loss of power in the transmission due to mainly friction losses. Another problem is that they cannot transfer high torques and powers due to slippage, friction and that they comprises flexible parts.

Recently, a new CVT was invented using a flexible tooth belt arranged at a conical wheel, see WO 02/08638. Although slippage and friction losses might be reduced in this invention there is still a great problem to transfer high torques and powers with a flexible belt.

U.S. Pat. No. 4,878,883 shows a continuously variable chain drive transmission having a hydraulic system for locating a number of diametrically opposed small gears on different radius at a sprocket wheel in order to achieve different effective diameters.

The problem with this is that sometimes the effective diameter matches the chain pitch but in between there will be effective diameters which will not match the chain pitch and thus the small gears will not engage in a recess in the chain but will slip. Due to this an uneven function of the transmission will occur. This transmission can only function in one rotary direction.

The aim in U.S. 2005/0148416 A1 is to overcome the pulsed drive output of U.S. Pat. No. 4,878,883. The variable sprocket IVT machine of U.S. 2005/0148416 A1 has a sprocket wheel with variable diameter comprising six slidably arranged sprockets which sprockets are controlled by a control element that can be moved towards or out from the central axis in order to change the effective diameter. This solution is too complex and can only function in one rotary direction.

None of U.S. Pat. No. 4,878,883 and U.S. 2005/0148416 A1 has a construction that can handle large differences in effective diameter. Thus they cannot achieve high gear ratios.

The object of the present invention is to simplify and overcome the previous problems with CVTs.

The essence of the invention is a gear assembly making up an imaginary gear wheel with variable pitch diameter, suitable for a continuously variable transmission, which comprises two gear tooth devices, the two gear tooth devices being radially movable.

Since the gear tooth devices are radially movable a continuous change of the pitch diameter of the imaginary gear wheel is possible to achieve and thus a continuous change of the gear ratio, and since there is at least one gear tooth engaged in a chain it is capable of transferring high torques and powers without any slippage and almost no friction loss. Due to the fact that the gear assembly only comprises two gear tooth devices it will be easier to manufacture, more compact, more reliable, easier to mend and maintenance will be quicker.

Preferably the gear tooth devices are directed about 180 degrees from each other within a range up to +/−20 degrees.

As information, in a conventional gear wheel with straight gear teeth it is basically always only one gear tooth at the time that transfers torque.

The two gear tooth devices may be driven (on the input side) alternately in order to transfer torque from the input side to the output side via the transmission chain. The gear tooth devices may be arranged at a shaft part each, the shaft parts being axially aligned and making up a gear box shaft (for example for the input side of a gear box). The gear tooth devices are radially arranged, one at each shaft part, opposed to each other in the gap of the gear box shaft between the aligned shaft parts. The transfer of torque takes place during the period when the gear tooth device is connected to a primary clutch.

It is also conceivable to let the gear tooth devices overlap and cooperate, i.e. both being connected to the primary clutches, during a period of time of each revolution, in other words during a portion of the circumference of the imaginary wheel. This is possible if the two gear tooth devices are connected to their primary clutch more than about half the circumference. Thus the two gear tooth devices will have an overlap in the primary clutch connections. Preferably, the transmission chain will surround more than 180 degrees and up to, for example, 320 degrees of the imaginary gear wheel.

Each gear tooth device, in turn, is driven by a primary clutch and/or a secondary clutch. For example, the primary clutch is a more powerful clutch than the secondary clutch and the primary clutch handles the torque transmission. According to a first embodiment of a clutch drive, each gear tooth device is driven substantially alternately by means of a primary clutch and a secondary clutch.

According to a second embodiment of the clutch drive, it is also possible to always drive the gear tooth device by means of the secondary clutch and then for a portion of a revolution, for ensample about half a revolution, also the primary clutch drives the gear tooth device, i.e. the clutches complement each other.

The gear tooth not transferring torque for the moment is driven by the secondary clutch. When this gear tooth device is to engage in the transmission chain it is still driven by the preferably weaker secondary clutch. In this way it is possible to have a smooth function of the alternation of the gear tooth devices even when the pitch diameter of the imaginary gear wheel and the pitch of the transmission chain do not match.

To further improve the smooth function of the alternation of the gear tooth devices, the gear ratio for the secondary clutch may be higher than the gear ratio for the primary clutch.

Preferably a mechanical way to engage and disengage the clutches is used. For example a rotating cam cooperating with a pin or a fixed cam cooperating with cam followers are used to control the clutches and its springs. Other conceivable ways are by means of hydraulics or electronics.

In order to support the transmission chain at its sides, two conical plates may be provided, one at each opposite end of two aligned shaft parts of the gearbox shaft. The conical plates are preferably synchronically movable towards and from each other along the axis of the gearbox shaft by means of an arm each connected to a gear-changing shaft by means of opposite directed threads on the gear-changing shaft.

One way of providing the radial movement of the gear tooth devices is to movably connect the gear tooth devices in radial direction at a radially arranged part each, whereby the parts being arranged on opposite, facing ends of the two aligned shaft parts of a gearbox shaft. For example, the gear tooth devices are synchronically movable radially inwards and outwards along the radially arranged parts by means of at least one lever each, arranged at the gear tooth device and at the shaft part, the lever being connected to the conical plates, which in turn are connected to the gear-changing shaft via the arms and thus the levers are movable :synchronically with the conical plates.

Another way of providing the radial movement of the gear tooth devices is to let the centrifugal force and/or let the conical plates push the gear tooth devices radially outwards, sliding along the conical plates when the conical plates are moved towards each other by means of turning the gear-changing shaft. In order to retract the gear tooth devices an electrical motor can be arranged and controlled via a sensor system. Of course it is conceivable to move the gear tooth devices both outwards and inwards by means of the electrical motor.

On the other hand when the gear tooth device should be retracted the transmission chain will urge the gear tooth devices radially inwards since the transmission chain will “expand” at the opposite side, for example the output side. It is also conceivable to arrange a spring between the radially arranged part and the gear tooth device that will balance the centrifugal force. It is also conceivable that the spring force is that high that the gear tooth device will be retracted by the spring when the conical plates move apart.

A further way of retracting the gear tooth devices is to connect the gear tooth devices to a first end of a chain which runs into a central opening in the conical plates and further through elongated holes in each part of the shaft, which holes extends axially. The chain is preferably connected at its second, opposite end to a cylinder stick provided in the elongated hole of the shaft part. This cylinder stick is then connected to the gear-changing shaft in order to synchronically retract the gear tooth devices when changing gears. This is a simpler way than the previously shown to provide the radial movement of the gear tooth devices.

One way of enhancing the gear ratio is to increase the diameter of the imaginary wheel. This can be achieved if the radially arranged part being longer and that the gear tooth device can be designed so that it can move further radially outwards. In this embodiment of the conical plates the centre of the conical plate has been turned out in order to make room for the longer radially arranged part and this gear tooth device.

In this way the gear tooth device can move a longer distance along the radially arranged part and thus make up an imaginary gear wheel having a greater diameter. This means that the gear ratio will increase accordingly. In order to support the chain all the way a circular cover is arranged over a portion of the central opening in the conical plate.

In order to provide further enhanced gear ratio it is conceivable to increase the diameter of the imaginary wheel, for example by arranging the gear tooth part on a guide, which in turn is arranged on another guide. In this way the gear tooth devices will have a telescope function. The outward radial movement can for example be achieved according to any of the above suggestions. The same counts for the retraction, although it is preferred to use the chain solution for the retraction. When using a telescoping gear tooth device a larger diameter of the imaginary gear wheel is possible to achieve. At the same time the transmission chain could be wider since the distance between the two supporting conical plates will be increased at the outer portions of the conical plates. If the width of the transmission chain is to be kept the same the angle of the conical plates may instead be changed.

According to a at the moment preferred embodiment, each gear tooth device comprises two gear teeth provided on a stick each, which sticks are connected to each other by means of a link. Preferably a first gear tooth protrudes further out in the radial direction than the second tooth.

A smooth function will be achieved if at least the first gear tooth stick is spring biased radially outwards, and thus movable radially inwards while the second gear tooth and its stick is thereby urged radially outwards due to the link.

In a second embodiment the gear tooth device comprises one gear tooth. The gear tooth device is movable lengthwise in a guide and spring biased radially outwards in this guide by means of at least one spring. The guide is arranged in an angle. When the tooth is going to engage in a chain, the tooth will in most cases hit a recess in the chain or hit a slope leading down to a recess.

If the tooth hits between the slopes, the chain will force the tooth radially inwards against the spring force sliding in the guide. At the same time the gear tooth device will move forwards in respect of the chain.

Due to this forward movement the tooth will move over to the slope in front and slide into the recess in front.

In a third embodiment each gear tooth device comprises one gear tooth and the gear tooth device is spring biased and movable in the rotational angle direction both forwards and backwards.

According to a first and a second aspect of a continuously variable transmission of this invention it comprises an input shaft, an output shaft connected to the input shaft via a first gear box shaft and a second gear box shaft by means of a transmission chain. The first gearbox shaft and the second gear box shaft comprising each a gear assembly according to any of the embodiments above, whereby the first gearbox shaft is driven by the input shaft, the second gearbox shaft is driven by the first gearbox shaft via the transmission chain, and the output shaft is driven by the second gearbox shaft.

A gear-changing shaft is connected via arms to the first gear box shaft and the second gear box shaft for synchronized movement of the two gear tooth devices per gear box shaft in order to decrease the pitch diameter at the first gear box shaft at the same time as the pitch diameter of the second gear box shaft increases; or vice versa.

According to a third aspect of a continuously variable transmission of this invention it comprises an input shaft, an output shaft connected to the input shaft via a gear box shaft and a gear wheel by means of a transmission chain. The gearbox shaft comprising a gear assembly according to any one of the embodiments above, whereby the gearbox shaft is driven by the input shaft, the gear wheel is driven by the first gearbox shaft via the transmission chain, and the output shaft is driven by the gear wheel; or vice versa.

### SHORT DESCRIPTION OF THE DRAWINGS

The present invention will now be described by means of some today preferred embodiments under referral to appended drawings, in which

FIG. 1 shows a top plan view of a first embodiment of a CVT of the present invention but with the overlying input and output shafts only in broken lines,

FIG. 2 shows a side plan view of a portion, in more detail, of the embodiment in FIG. 1,

FIG. 3 shows a cam axle part,

FIG. 4 shows an embodiment of a shaft part provided with a lever and a conical plate, partially cut away in this view,

FIG. 5 shows the shaft part of FIG. 4 rotated about 90 degrees but without conical plate,

FIG. 6 shows another embodiment of a shaft part provided with a motor and a conical plate, partially cut away in this view,

FIG. 7 shows a stop arranged at a spline part,

FIG. 8 shows a preferred embodiment of two gear tooth devices, the first partially in a broken view not to cover the second, which is positioned behind, arranged at the opposite shaft part, and a chain,

FIG. 9a shows an alternative embodiment of a gear tooth device, the first partially in a broken view not to cover the second, which is positioned behind, arranged at the opposite shaft part, and a chain, the first gear tooth device in two positions, namely I and III,

FIG. 9b shows the first gear tooth device of FIG. 9a in a position II on its way to engage in the chain,

FIG. 9c shows an alternative chain,

FIG. 10 shows a top plan view of a second embodiment of the present invention in two positions, namely I and II,

FIG. 11 shows a side plan view of the embodiment in FIG. 10, see arrows in FIG. 10, in two positions, namely I and II, and

FIG. 12 shows a further example of the radial movement of the gear tooth device, another transmission chain, and the possibility to have overlapping connections of the gear tooth devices to the primary clutches, and

FIG. 13 shows a side plan view of a portion, in more detail, of a second embodiment of a clutch drive,

FIG. 14 shows a housing of the clutch drive in FIG. 13,

FIG. 15a shows in a plan view an intermediate disc of the clutch drive in FIG. 13,

FIG. 15b shows in a side view the intermediate disc of FIG. 15a,

FIG. 16a shows in a side view cam followers of the clutch drive in FIG. 13,

FIG. 16b shows in a plan view the cam followers of FIG. 16a and a possibility to adjust the position of the cam followers to the intermediate disc of the clutch drive in FIG. 13,

FIG. 16c shows the view according to A-A in FIG. 16a,

FIG. 17 shows the possibility to adjust the position of the cam followers to the intermediate disc of the clutch drive in FIG. 13,

FIG. 18a shows in a plan view a fixed cam of the clutch drive in FIG. 13,

FIG. 18b shows a top view of the cam in FIG. 18a,

FIG. 19a shows a side view of a further embodiment of a shaft part,

FIG. 19b shows the shaft part of FIG. 19a rotated about 90 degrees,

FIG. 19c shows a plan view of the shaft part of FIG. 19a

FIG. 20 shows a side plan view of a portion, in more detail, of a second embodiment of a CVT and a preferred way to retract the gear tooth devices,

FIG. 21 shows in detail a portion of the control of the retraction of the gear tooth devices,

FIG. 22 shows a plan view of a second embodiment of a CVT of the present invention but with the overlying input and output shafts taken away,

FIG. 23 shows a further embodiment of the gear tooth devices, radially arranged parts and conical plates,

FIG. 24 shows a telescoping gear tooth device,

FIG. 25a shows the telescoping gear tooth device in its most expanded position, and

FIG. 25b shows the telescoping gear tooth device in its most retracted position.

### DETAILED DESCRIPTION OF PREFERRED EMBODIMENTS

The present invention will now be described by some embodiments. In order to enhance the understanding of the function of the invention and its different parts and assemblies, the invention will be described in the way it will function in a continuously variable transmission (CVT).

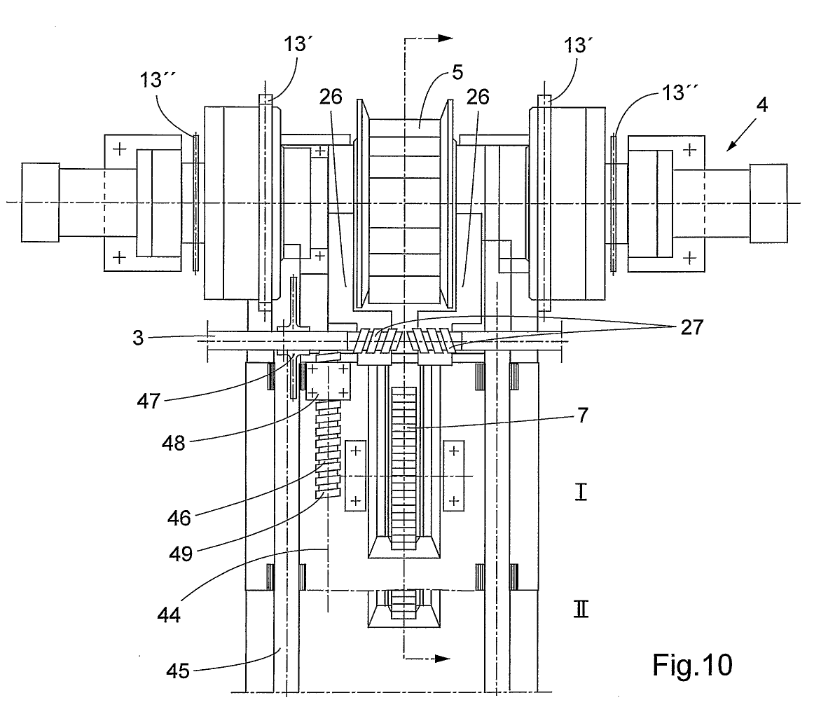

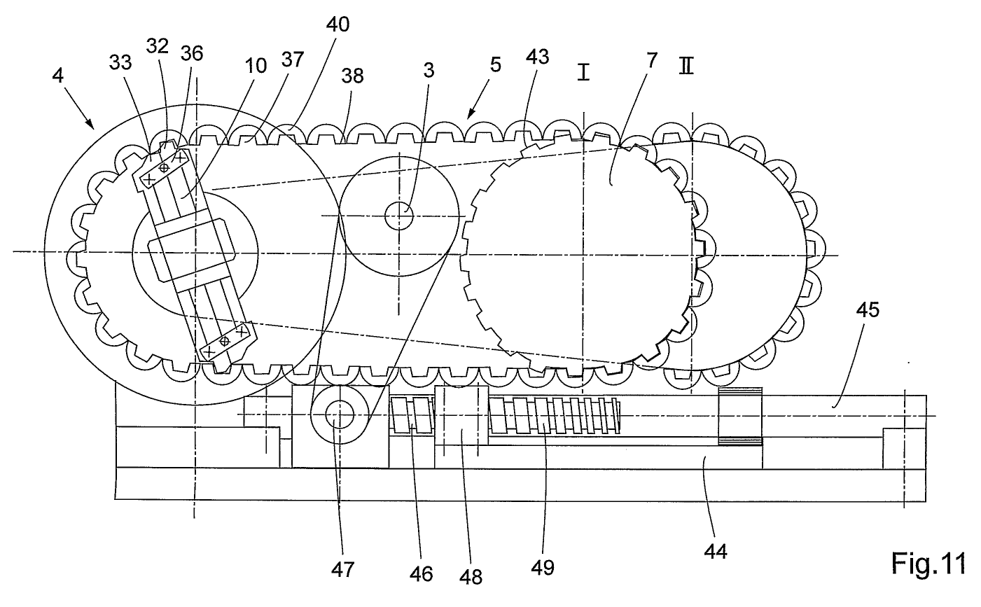

A CVT according to the invention comprises an input shaft 1, an output shaft 2, at least one gearbox shaft 4, preferably used for the driving side (input side) of the CVT, connected to the input shaft 1, a transmission chain 5 between the gearbox shaft and a second gearbox shaft 6 or a gear wheel 7, see FIGS. 10 and 11, whereby the second gearbox shaft 6 or the gear wheel 7 is driven and connected to the output shaft 2.

A gear-changing shaft 3 is connected via arms 26 to the first gear box shaft 4 and the second gear box shaft 6 for synchronized movement of the two gear tooth devices per gear box shaft 4, 6 in order to decrease the pitch diameter at the first gear box shaft 4 at the same time as the pitch diameter of the second gear box shaft 6 increases; or vice versa.

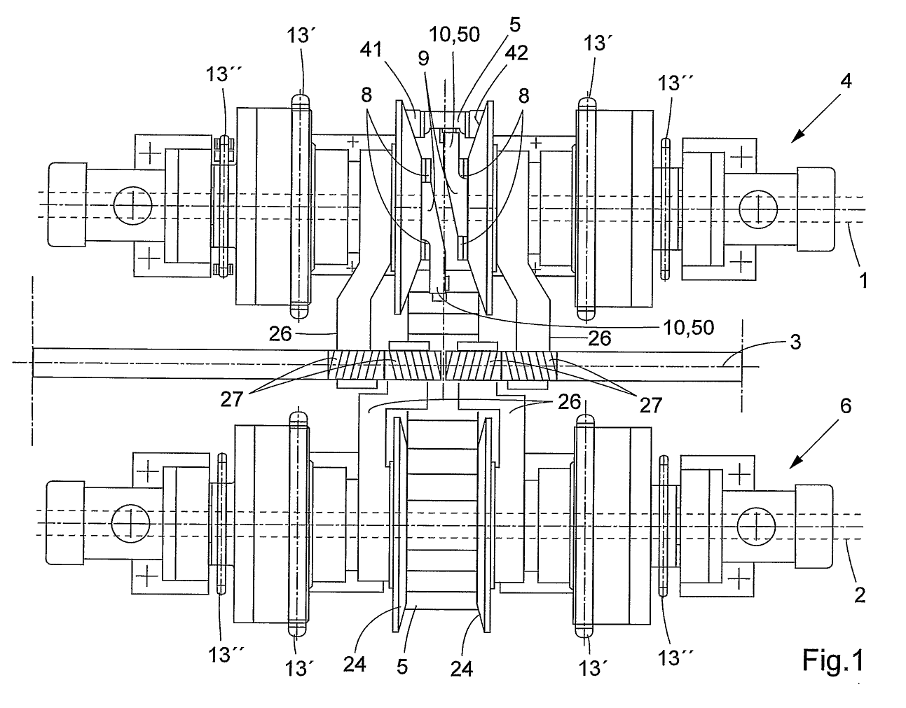

According to a first and a second embodiment the CVT comprises two gearbox shafts, a first 4 and a second 6 (see FIGS. 1, 2 and FIGS. 20, 22). According to a third embodiment the CVT comprises one gearbox shaft 4 and a gear wheel 7 (see FIGS. 10 and 11).

All three embodiments use a first gearbox shaft 4 for the input side of the gearbox. This will be described now. Although, it should be understood that the second gearbox shaft 6 is made up in the same way but is used in the first and second embodiment for the output side of the gearbox, thus working in the opposite way taking up torque transferred from the first gearbox shaft 4 via the transmission chain 5.

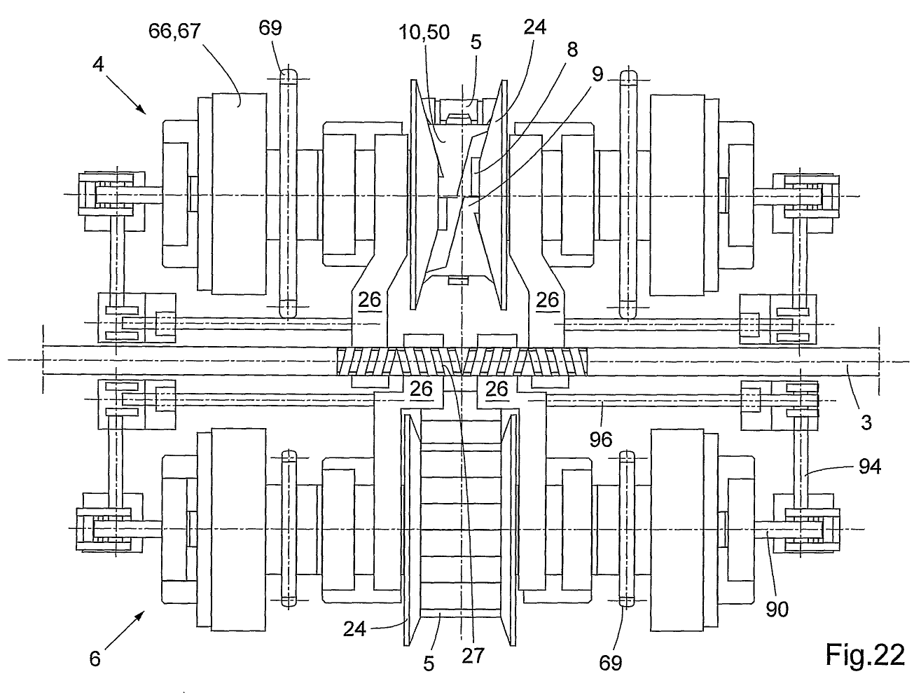

The gearbox shaft 4, 6 is divided into two shaft parts, see FIGS. 1 and 22, having a radially arranged part 8 provided at each opposite end, facing each other, preferably having some sort of shaped guide such as rhombic, quadratic, elliptic or the like cross section, preferably a spline, thus the radially arranged part will hereafter be called a spline part 8. Movably along the spline part 8 a sleeve 9 is preferably attached, which holds or comprises integrally a gear tooth device 10, 50. The gear tooth device 10, 50 will be further described below, see also FIGS. 8, 9, 24, 25a and 25b. The two parts of the gearbox shaft 4 will alternately drive the chain 5 by means of the gear tooth devices 10, 50 of each part.

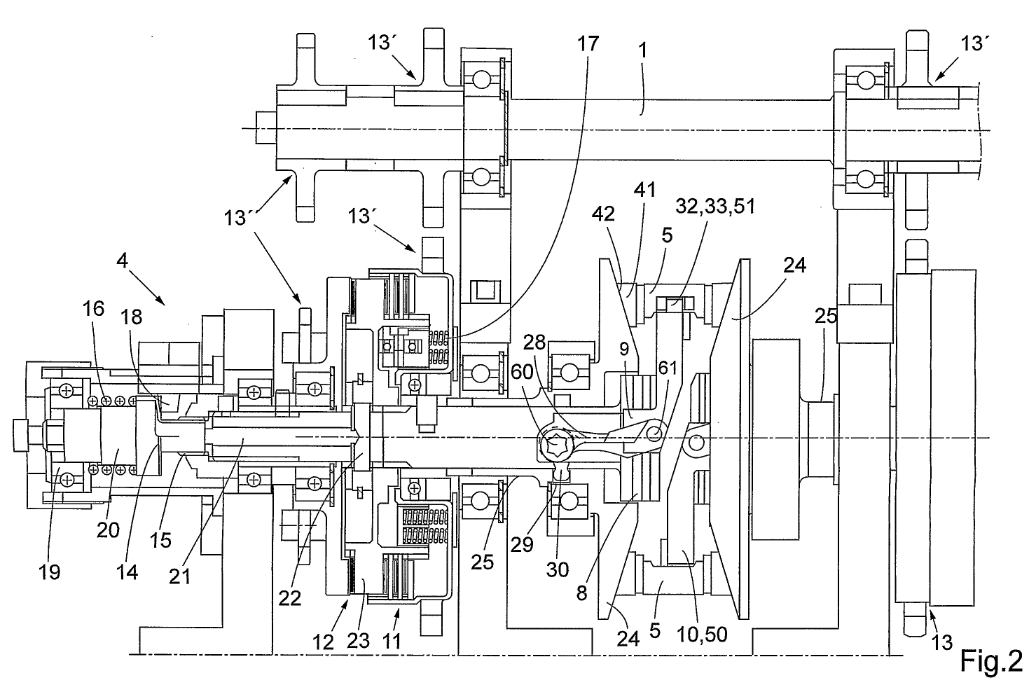

In order to alternate, each shaft part may be driven by means of a primary clutch 11, 66 and/or a secondary clutch 12, 67. These clutches 11, 12, 66, 67 may be disc clutches. In a first embodiment, the first gearbox shaft 4 is connected to the input shaft 1 at four positions, two for each shaft part, by means of four gear units 13, two primary gear units 13′ and two secondary gear units 13″ see FIG. 2. The gear ratio for the primary gear unit 13′ connected to the primary clutch 11 is lower than for the secondary gear unit 13″ connected to the secondary clutch 12, i.e. the part of the shaft at the moment connected via the secondary clutch rotates faster then the other part, which at the same moment is connected via the primary clutch 11. The input shaft 1 is preferably arranged above the first gearbox shaft 4 as shown in FIG. 2 (not shown in FIG. 1).

The primary clutch 11 is a more powerful clutch, for example provided with three discs, since the primary clutch will handle the torque transmission. The secondary clutch 12 is less powerful, for example provided with only one disc, since the secondary clutch will mainly only drive one shaft part.

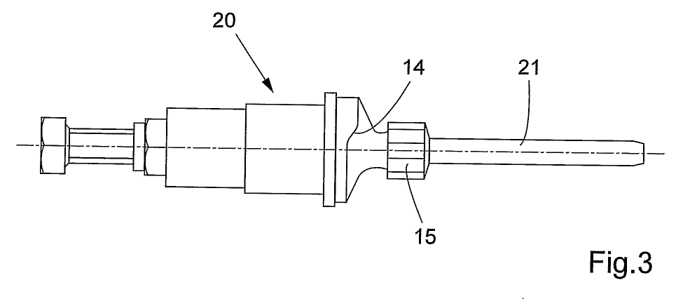

The alternation between the primary clutch 11 and the secondary clutch 12 is obtained by means of a rotatable cam, for example a cam axle part 20, see FIG. 3, having a cam curve 14 arranged near the free end of each part of the gearbox shaft 4, 6. The cam axle part 20 is movable in the axial direction due to suspension via splines 15 at the same time as it is rotatable in at least one bearing 19 arranged in a housing or mounting of the CVT. The cam axle part 20 has a pin 21 extending in the axial direction, which can actuate the clutches 11, 12 via a central clutch plate 23 arranged in between the clutches 11, 12.

A primary coil spring 16 acts on the cam axle part 20 so that the pin 21 forces, via a bar 22 provided on the central clutch plate 23, the primary clutch 11 to engage and overcome the spring force of the at least one secondary spring 17 as long as the cam curve 14 is in its lower position, i.e. does not come in contact with a pin 18 arranged in the housing or mounting of the CVT. By forcing the central clutch plate 23 towards the primary clutch 11 the secondary clutch 12 disengages, see FIG. 2.

When the cam curve 14 is in its upper position the cam curve will come in contact with the pin 18 and the cam axle part 20 will be forced to move axially towards the free end and against the force of the primary coil spring 16. In this way the primary clutch 11 disengages since the at least one secondary spring 17, preferably several coil springs evenly distributed around the clutch, will force the central clutch plate 23 towards the secondary clutch 12 so that it engages. Of course it is conceivable to alternate the engagement of the primary and secondary clutches by means of hydraulics or electronics.

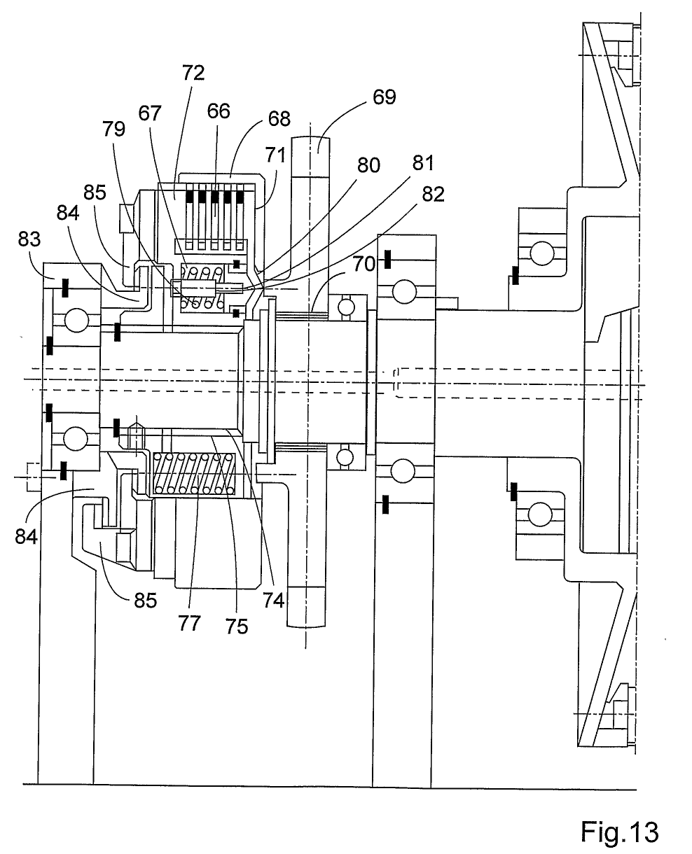

A second embodiment of the clutch drive is simplified in that the primary and secondary clutches are driven at the same speed from the input shaft 1, for example by means of a single gear unit 69 for each shaft part, see FIG. 13. The primary clutch 66 is still a more powerful clutch than the secondary clutch 67. Preferably, the secondary clutch 67 will always be engaged and the primary clutch 66 will only be engaged for a portion of the revolution, for example about half of the revolution.

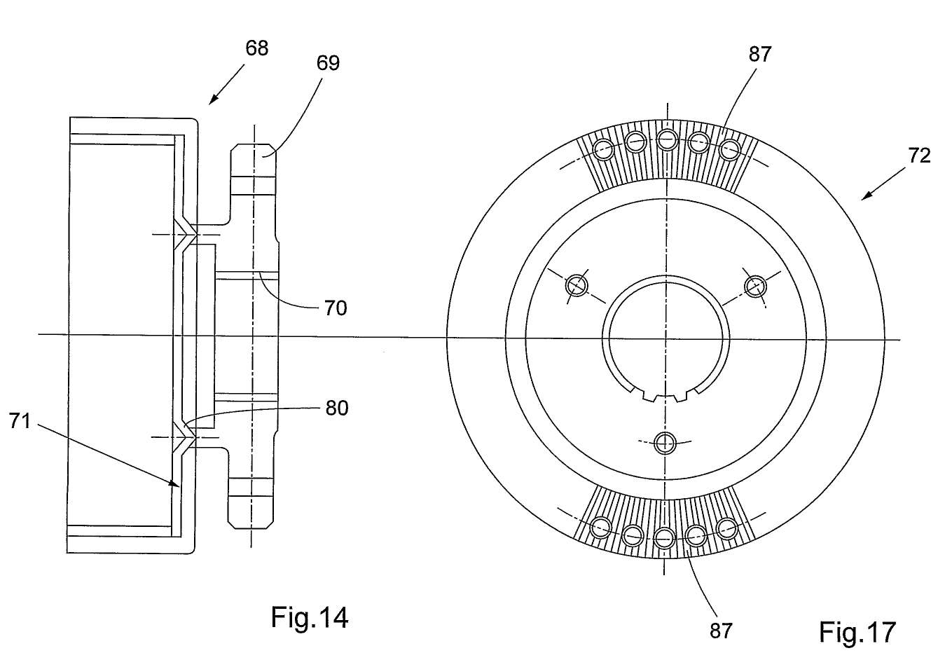

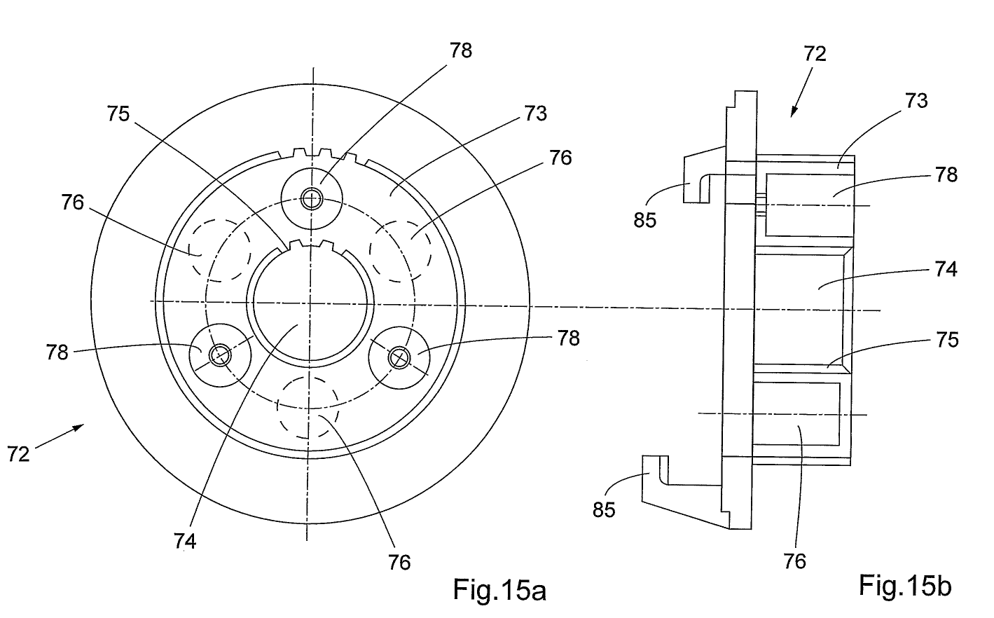

In FIGS. 13-18 the second embodiment of the clutch drive is shown. It comprises a housing part 68 connected to the gear unit 69. The gear unit 69 is arranged on the shaft part by means of a bushing 70. Inside the housing part 68 is a clutch surface 71 provided to engage with the discs of the primary clutch 66, see FIG. 14. The clutch discs of the primary clutch are arranged on an intermediate disc 72 comprising a circle portion 73 having an inner through going hole 74 provided with splines 75 or the like for engagement with the shaft part, see FIGS. 15a, b.

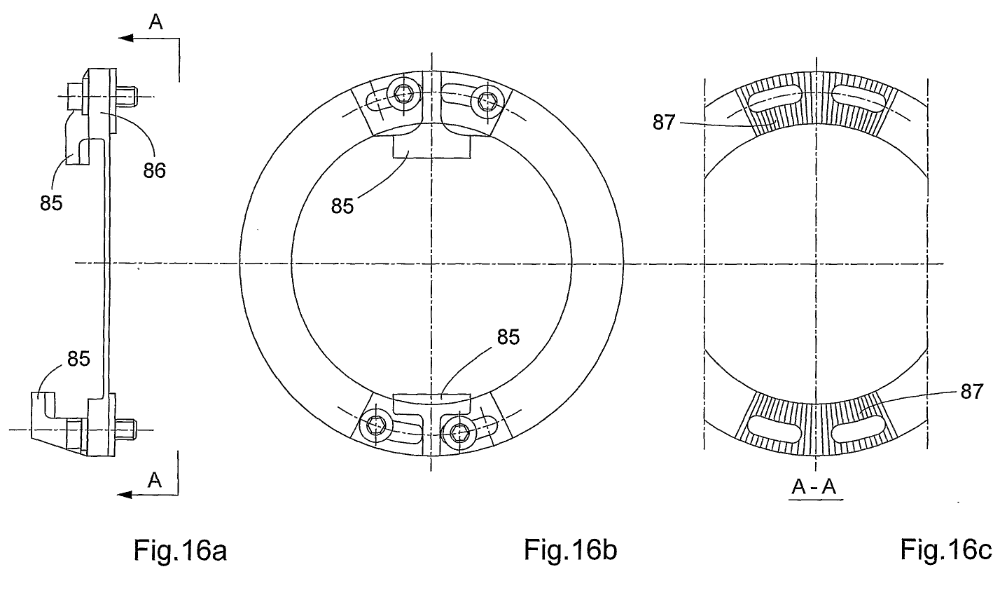

The intermediate disc 72 is preferably provided with two cam followers 85. These cam followers 85 may be integrally provided or. preferably mounted to the intermediate disc 72. As can be seen in FIGS. 16a, b, c, the abutting sides of a part 86 with cam followers 85 and the intermediate disc 72 is provided with locking ribs 87. Thus the degree when the cam followers 85 hits the cams 84 can be adjusted by mounting the part 86 to the intermediate disc 72 at a desired position.

In the circle portion 73 a number of recesses 76 are provided, in the shown embodiment three, for corresponding numbers of primary clutch springs 77. Another set of recesses 78 are provided in the circle portion 73, in the shown embodiment three, for secondary clutch springs 79. The recesses 78 are preferably arranged in between the recesses 76. The secondary clutch may be a disc clutch, for example with one clutch disc, or may be a clutch having a number of dents 80 provided in the clutch surface 71 of the housing part 68 and cooperative plunges 81. This type of clutch is more of a synchronizing clutch.

Preferably both the dents 80 and the plunges 81 are conical. An abutment 82 functions as a stop for the axial movement of the plunge 81. This is preferably designed so that the plunge 81 cannot move totally out of the dent 80.

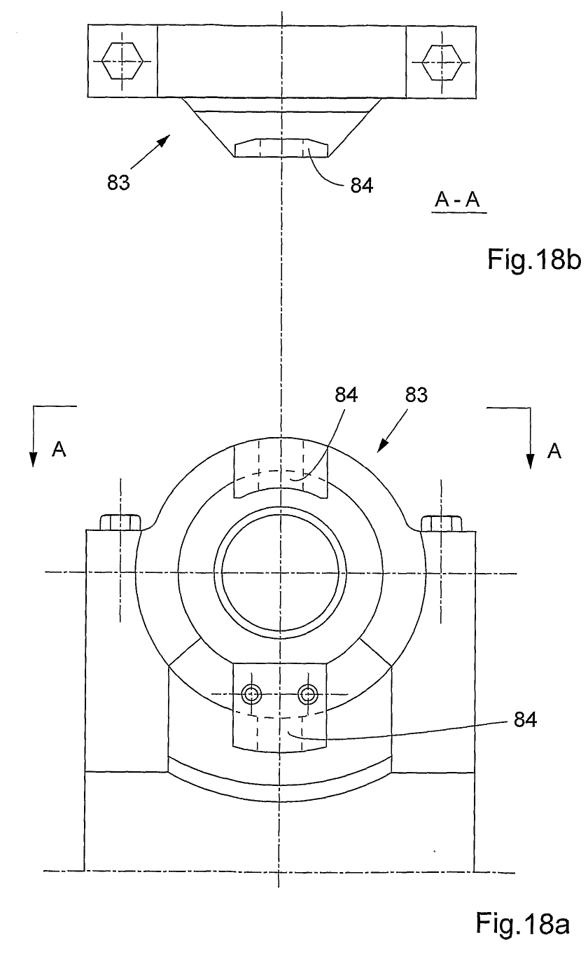

A preferred way to engage and disengage the clutches 66, 67 is shown in FIGS. 13 and 18a, b. A fixed cam part 83 is preferably provided with two cams 84 positioned 180 degrees from each other, radially and axially displaced. The two cams 84 cooperate with two cam followers 85 provided at the intermediate disc 72. The cam followers 85 are also positioned 180 degrees from each other, radially and axially displaced at corresponding distances. Of course it is conceivable to have only one cam 84 and one cam follower 85.

When the cam followers 85 passes the cams 84 (at the same time) the intermediate disc 72 will be displaced outwards towards the outer end of the shaft part against the force of the primary springs 79 and thus the clutch discs will be released, i.e. the primary clutch 66 will be disengaged. The length of the cams 84 in rotational distance corresponds to the portion of the revolution that the primary clutch is disengaged, preferably about half of the revolution.

The secondary clutch having dents 80 and plunges 81 will always drive the shaft part and thus the gear tooth device 10, 50. When the gear tooth device is going to engage in the transmission chain 5 a small slippage or displacement of the secondary clutch 67 may be needed so that the gear tooth device 10, 50 will correctly enter the recess in the transmission chain 5. When the entering/engagement of the gear tooth device in the chain 5 is completed the primary clutch 66 will be engaged and then locks the possible displacement of the plunges 81 in the dents 80. After about half of a revolution the primary clutch 66 is disengaged, which will give the plunges 81 the possibility to slide back into the centre of the respective dents 80. In this way the gear tooth devices 10, 50 will be synchronized again back to their mutual positions, for example 180 degrees from each other.

It is also conceivable to control the clutches 66, 67 by means of hydraulics or electronics.

When using a same speed clutch drive the gear tooth device must be able to perform a slight position change at least backwards in order to provide a smooth drive. Thus the force of the spring controlling the slight position change of the gear tooth device would preferably not be stronger than the spring force of the secondary clutch. Or, in the case of a secondary clutch 67 using dents 80 and plunges 81, the spring control on the gear tooth device is not needed, because of the possibility to displace the plunges 81 relative the centre of the dents 80.

Thus a simpler and more compact clutch drive is provided, which will reduce the friction and save both weight and space for the CVT. Also the cam assembly is provided closer to the middle of the gear box shaft making the CVT even more compact. This embodiment will also reduce the wear.

Although, if the main clutch for engaging and disengaging the transmission of the vehicle is removed in favour of the clutches of the CVT also the secondary clutch must be disengable, for example by further displacement of the clutch assembly so that the force of the springs of the secondary clutch is overcome if using a disc clutch or taking away the stop in the plunges if a clutch with plunges and dents is used.

At each of the opposing ends of the shaft parts of the gearbox shaft 4, 6 a conical plate 24 is attached around the shaft via a sleeve 25. These plates 24 serve as side support for the transmission chain 5. The sleeve 25 is connected to the gear-changing shaft 3, see FIG. 1, by means of an arm 26 fixedly attached at the sleeve and provided with an internal thread (not shown) at the other end surrounding the gear-changing shaft 3, which in turn is provided with an outer thread 27. When turning the gear-changing shaft 3 the arm 26 will move along the axis of the shaft 3 and thus move the conical plate 24 along the axis of the gearbox shaft 4, 6.

Both of the conical plates 24 will be synchronically moved towards or from each other at each gearbox shaft 4, 6 due to the fact that the gear-changing shaft 3 is provided with opposite directed threads 27 for the two arms 26 of each gearbox shaft 4, 6.

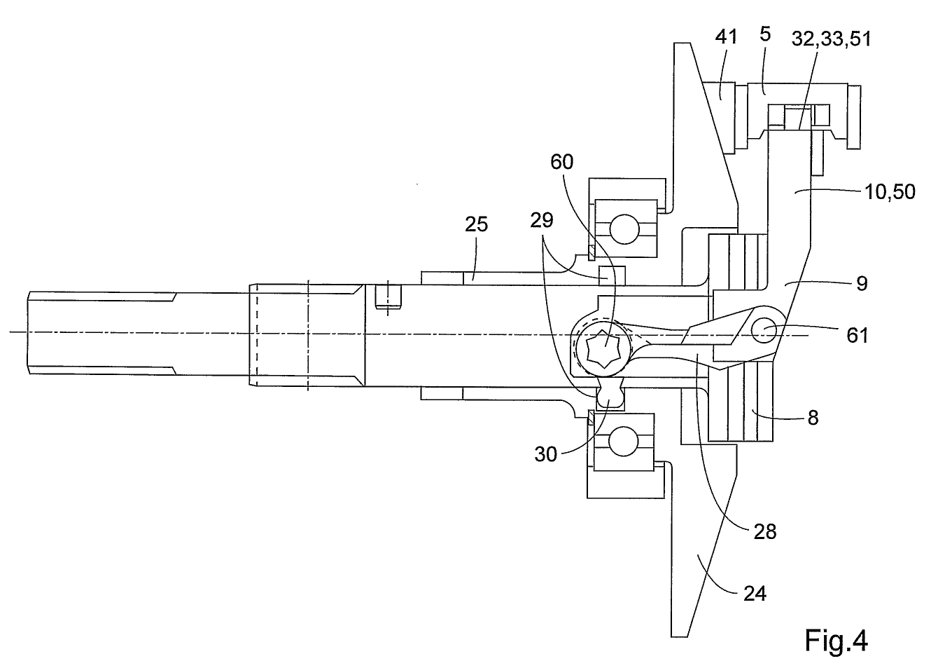

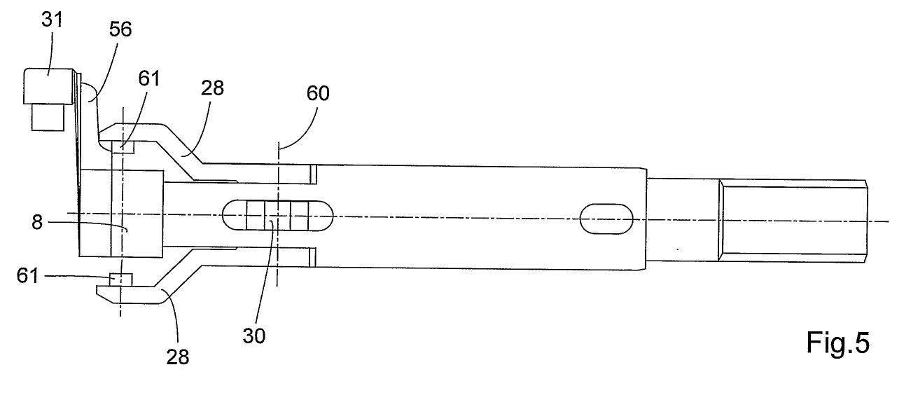

In one embodiment, at least one lever 28 pivotally arranged around an axle 60 on each of the parts of the gearbox shaft 4, 6 is connected to the conical plate 24, preferably in the sleeve 25 of the conical plate 24, for example in a groove 29 by means of a pin 30, and to the sleeve 9 movable along the spline part 8 at the end of the shaft part, for example by means of a pin 61, see FIGS. 2, 4 and 5. Preferably two levers 28 are arranged, one at each side of the part of the gearbox shaft 4, 6.

When the conical plate 24 is moved towards the free end of the gearbox shaft 4, 6 the sleeve 9 will be moved, retracted, along the spline part 8 towards the centre of the gearbox shaft 4, 6. Thus will each gear tooth device 10, 50 be retracted, too.

When the conical plate 24 is moved towards the opposite conical plate 24 the sleeve 9 will be moved, protruded, along the spline part 8 towards the perimeter of the gearbox shaft 4, 6. The synchronic movement of the conical plates 24 will thus also be a synchronic movement of the gear tooth devices 10, 50 for each gearbox shaft 4, 6.

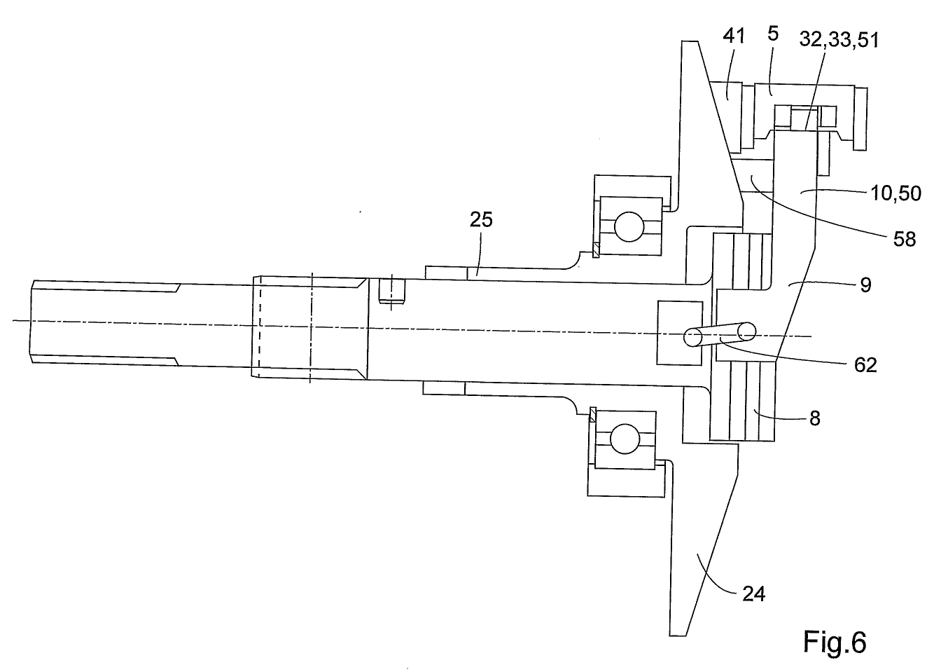

In a second embodiment, see FIG. 6, the gear tooth devices 10, 50 are moved outwards by means of the centrifugal force sliding along the conical plates with a support 58 when the conical plates are moved towards each other by means of turning the gear-changing shaft. In order to retract the gear tooth devices an electrical motor 59 is arranged having a lever 62 and controlled via a sensor system (not shown). Of course it is conceivable to move the gear tooth devices 10, 50 both outwards and inwards by means of the electrical motor 59. This results in a simpler shaft part.

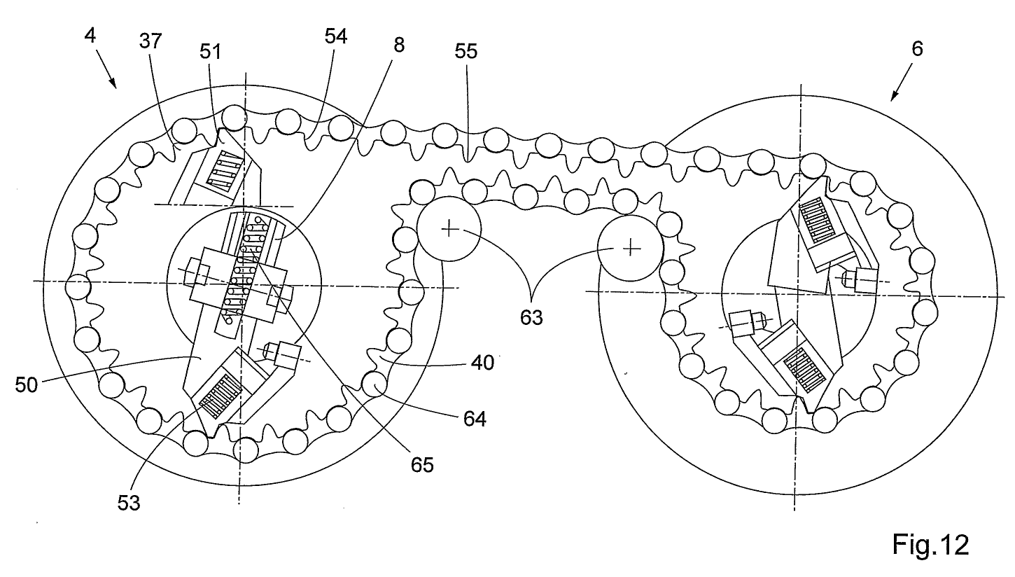

It is also conceivable, see FIG. 12, to arrange a spring 65 between the radially arranged part 8 and the gear tooth device 10, 50 that will balance the centrifugal force. The gear tooth device 10, 50 will move outwards sliding along the conical plates 24 when the conical plates 24 are moved towards each other by means of turning the gear-changing shaft 3.

On the other hand when the gear tooth device 10, 50 should be retracted the chain 5 will urge the gear tooth devices 10, 50 radially inwards since the chain 5 will “expand” at the opposite side, for example the output side, i.e. the second gearbox shaft 6 will increase its pitch diameter or the gear wheel 7 will move away from the first gearbox shaft 4. It is also conceivable that the spring force is so high that the gear tooth device 10, 50 will be retracted by the spring 65 when the conical plates 24 move apart.

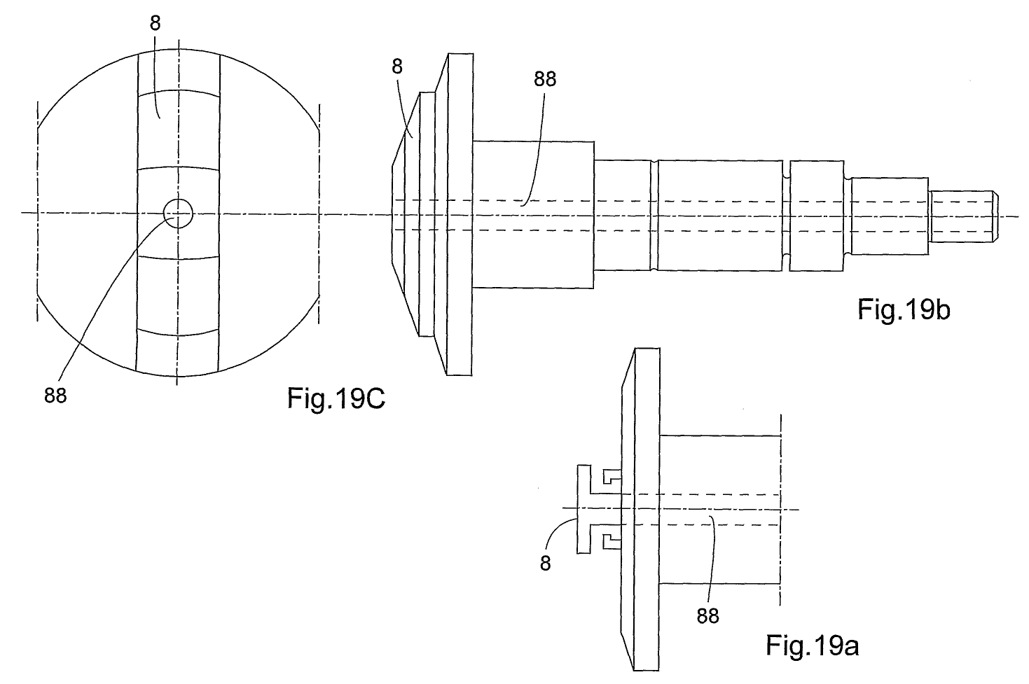

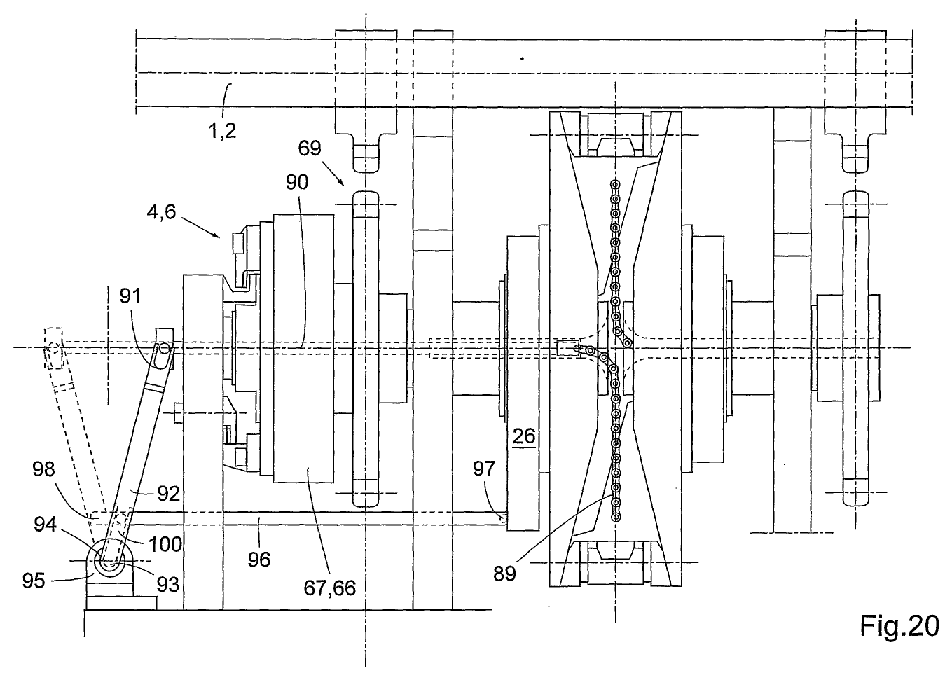

In FIGS. 19a, b, c a further embodiment of the shaft part is shown. The shaft part is shown without its conical plate. Along the antis of the shaft part an elongated, preferably cylindrical, hole 88 is provided. The radially, arranged part 8 extends over most of the end diameter and preferably equal distance from the centre. A further way to retract the gear tooth device sliding along the radially arranged part 8 is to connect the gear tooth device to a first end of a chain 89 which will run into the centre of the radially arranged part 8 and further through the elongated hole 88 in the shaft part. Preferably the second end of the chain 89 is connected to a cylindrical stick 90 arranged in the elongated hole 88, see FIG. 20.

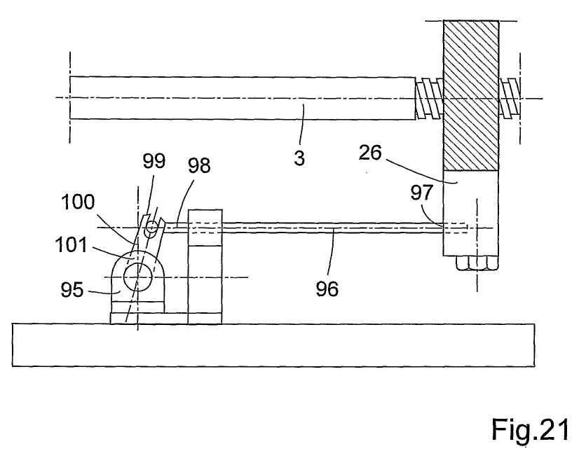

The cylindrical stick 90 in turn is connected to the gear-changing shaft 3 in order to have a synchronized movement of the gear tooth device, see FIGS. 20, 21 and 22. The stick 90 is connected to a first 91 end of a first link 92. The second end 93 of the first link 92 is connected to a synchronizing shaft 94 arranged in a bracket 95 at a foundation. The synchronizing shaft 94 is controlled by the gear-changing shaft 3. By turning the gear-changing shaft 3 the arms 26 move synchronically.

A rod 96 is connected to the respective arm 26 at its first end 97 and with its second end 98 to a second end 99 of a second link 100. The first end 101 of the second link 100 is connected to the synchronizing shaft 94. When the arm 26 move the synchronizing shaft 94 will move and thus the first link 92 will move, too, and move the stick 90 inwards or outwards in the elongated hole 88. The stick 90 actuates the chain 89 and thus the gear tooth device 10, 50. The differences in length of the first 92 and the second 100 links correspond to the different travel distances of the arm 26 and the gear tooth device 10, 50, respectively.

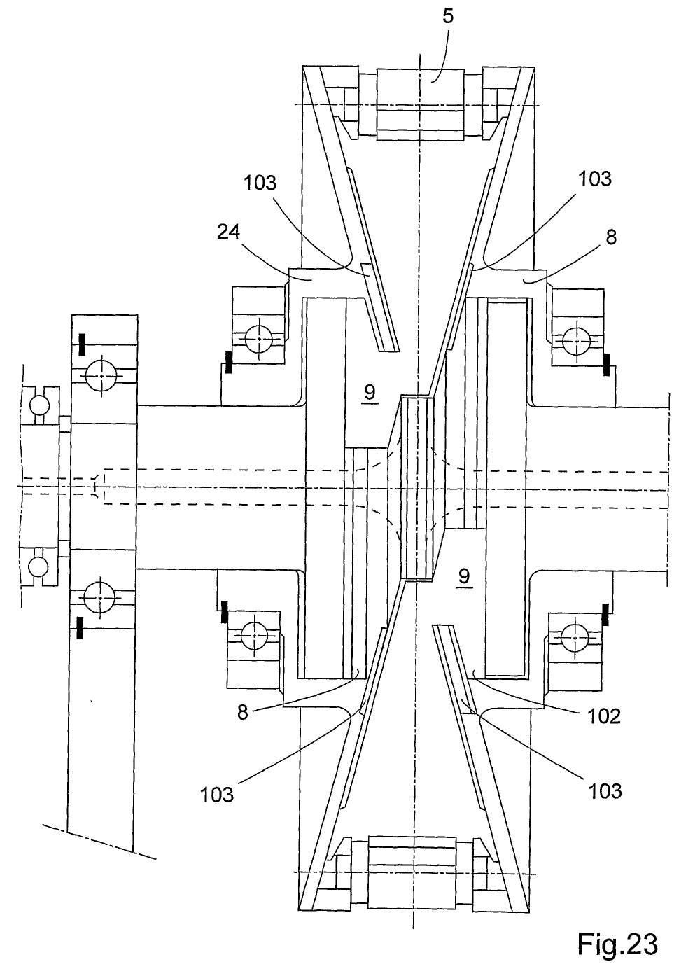

An advantage of the radially arranged part 8 being longer than in the previously shown embodiments is that the sleeve 9 can be designed so that it can move the gear tooth device further radially outwards. In FIG. 23 the sleeve 9 is shown and also an adapted conical plate 24. In this embodiment of the conical plates 24 the centre 102 of the conical plate 24 has been turned out in order to make room for the longer radially arranged part 8 and this sleeve 9.

In this way the sleeve 9 can move a longer distance along the radially arranged part 8 and thus make up an imaginary gear wheel having a greater diameter. This means that the gear ratio will increase accordingly. In order to support the chain 5 all the way a circular cover 103 is arranged over a portion of the central opening 102 in the conical plate 24.

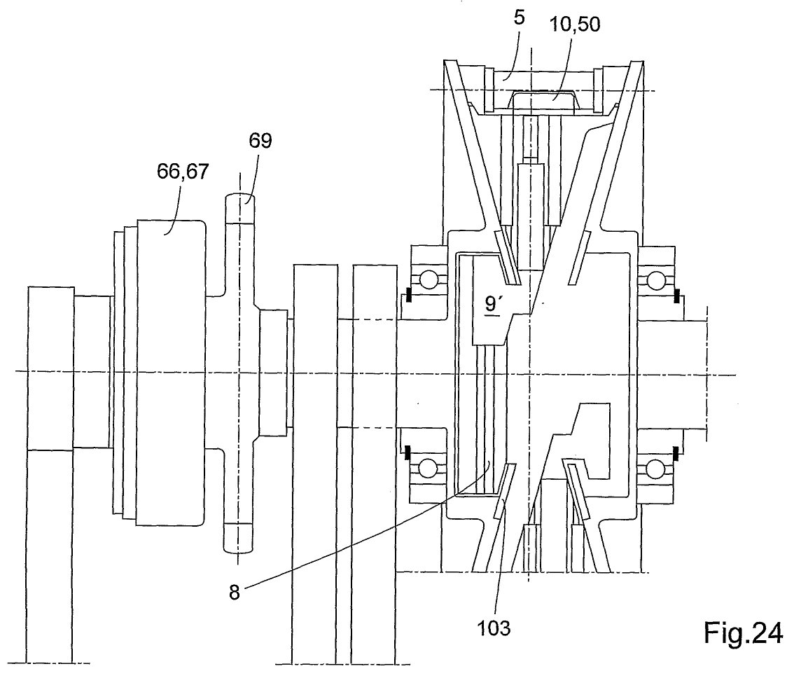

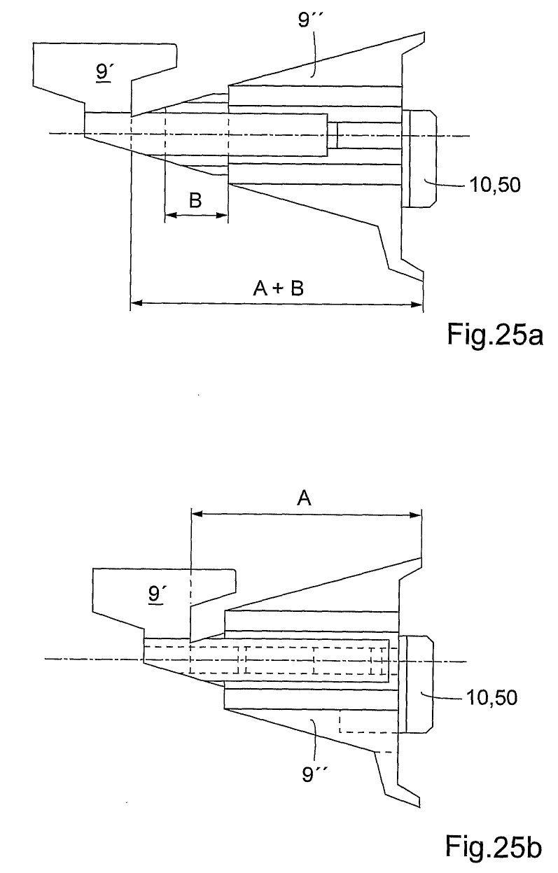

Another conceivable way to further extend the diameter of the imaginary gear wheel and thus increasing the gear ratio is to arrange more than one sleeve 9 between the radially arranged part 8 and the gear tooth device 10, 50 so that a first sleeve 9′ slides along the radially arranged part 8 and this first sleeve 9′ also is provided with some sort of shaped guide along which a second sleeve 9″ slides, see FIGS. 24 and 25a, b. The gear tooth device 10, 50 will thus be arranged in the second sleeve 9″. In this way it will have a telescoping function. Of course it is conceivable to arrange more than two sleeves if desired.

The outward radial movement of the gear tooth devices 10, 50 can for example be achieved according to any of the above suggestions, for example pushed radially outwards by the conical plates 24. The retraction of the gear tooth devices 10, 50 can for example be done according to any of the above described suggestions, although it is preferred to use the chain 89 solution for the retraction. The transmission chain 5 could be wider since the distance between the two supporting conical plates 24 will be increased. If the width of the transmission chain 5 is to be kept the same, the angle of the conical plates may instead be changed.

According to the first embodiment of the clutch drive, the two gear tooth devices 10, 50 will be directed about 180 degrees from each other but within a range up to +/−20 degrees since they will alternately be driven with different rotational velocities due to if they are driven via the primary clutch 11 or the secondary clutch 12, see FIG. 8. Either, they will be driven by different clutches except maybe for a transfer period when alternating the drive from primary to secondary and vice versa or, see FIG. 12, the gear tooth devices 10, 50 may both be driven at the same time by the primary clutch 11 for a period of time, for example corresponding to a rotational angle portion, such as 90 degrees.

The two gear tooth devices 10, 50 will thus form a diameter corresponding to an imaginary gear wheel and this diameter will change depending on if the gear tooth devices 10, 50 are retracted or protruded by means of the gear-changing shaft 3. In this way it is possible to change gear continuously by continuously changing the diameter of the imaginary gear wheel made up by the two gear tooth devices 10, 50.

According to the first embodiment where the gear tooth devices 10, 50 substantially alternates, one shaft part of the gearbox shaft 4 is driven via the primary clutch 11 and the gear tooth device 10, 50 is engaged in the chain 5 driving the chain 5, when operating. At this moment the other gear tooth device 10, 50 on the opposite part of the gearbox shaft 4 is driven via the secondary clutch 12 and directed about 180 (depending on present diameter of the two gear tooth devices 10, 50 arid chosen chain pitch) degrees from the driving, primary gear tooth device 10, 50.

When the driving gear tooth device 10, 50 runs off the chain 5 a change over from the primary clutch 11 to the secondary clutch 12 occurs by means of the cam axle part 20, as described above. The secondary clutch 12 runs with a higher rotational velocity than the primary clutch 11 therefore the gear tooth device 10, 50 changing from being driven by the primary to the secondary clutch will increase its rotational velocity and thus it will run faster than the other gear tooth device 10, 50 and thus “race” away from the other gear tooth device 10, 50 which at this moment has changed over to drive the chain 5 and being driven by the primary clutch 11.

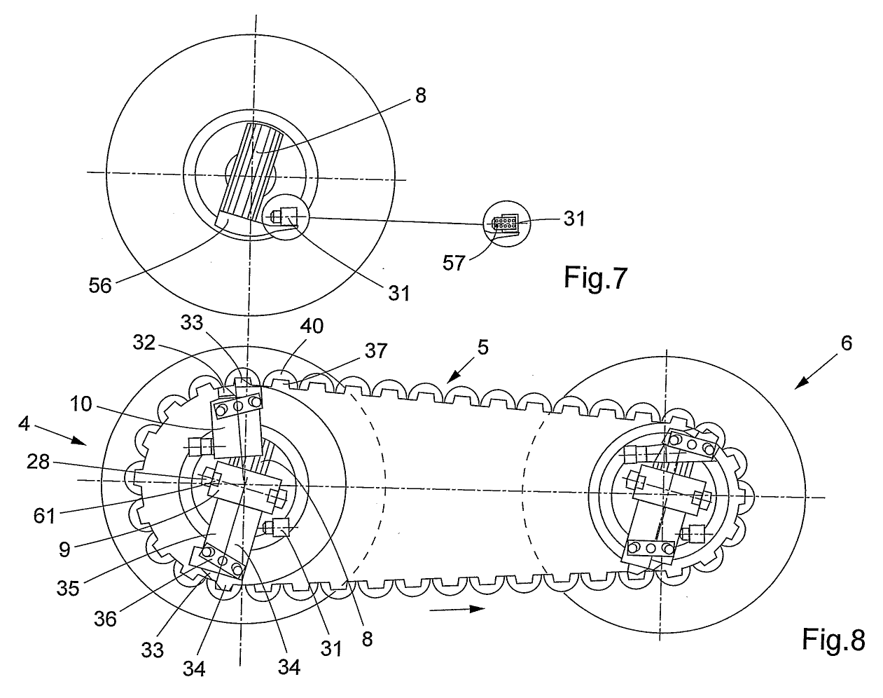

The for the moment secondary gear tooth device 10, 50 will run at the higher velocity until it hits a stop 31 positioned on an arm 56 on the spline part 8 connected to the other gear tooth device 10, 50. The stop 31 is preferably biased by a spring 57 in order to make the running of the gearbox smooth and also form an adjustment allowance, see FIG. 7. The force of the spring 57 is greater than the force of the secondary clutch 12. Then, the for the moment secondary gear tooth device 10, 50 will come into such a position that it will engage again in the chain 5.

This cycle goes on and on and in this way the two gear tooth devices 10, 50 will alternate to drive the chain 5.

The smooth engaging of the gear tooth device is possible because it is driven by the weaker secondary clutch 12. Another factor is that the secondary clutch drives the gear tooth device 10, 50 faster than the engaged gear tooth device arid thus it will give some transfer time for the secondary gear tooth device 10, 50 to engage in the chain 5 before it starts to drive the chain 5.

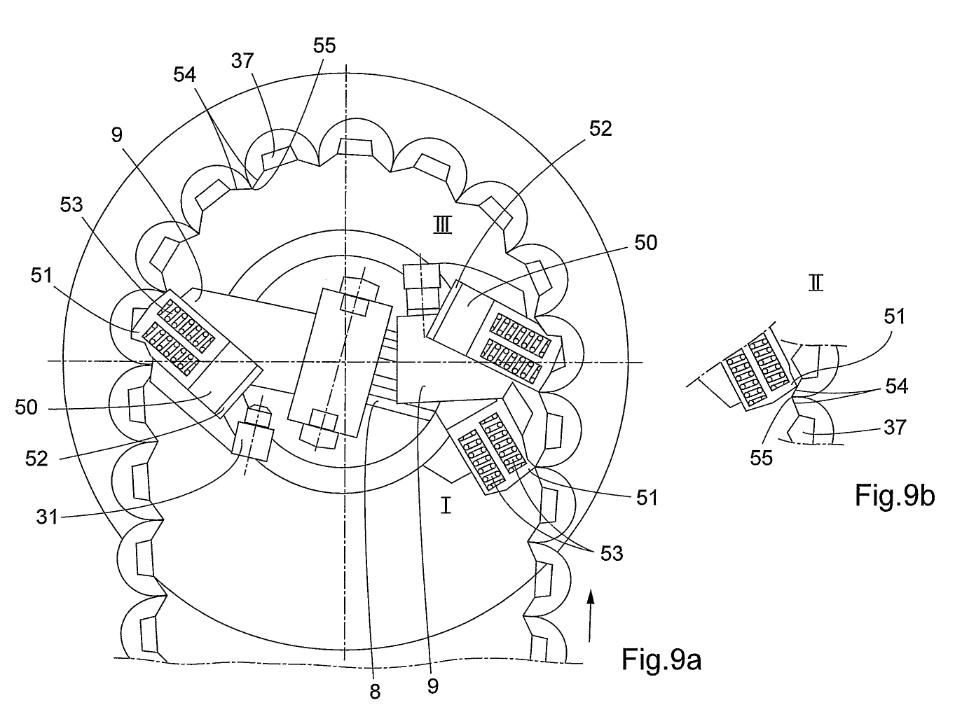

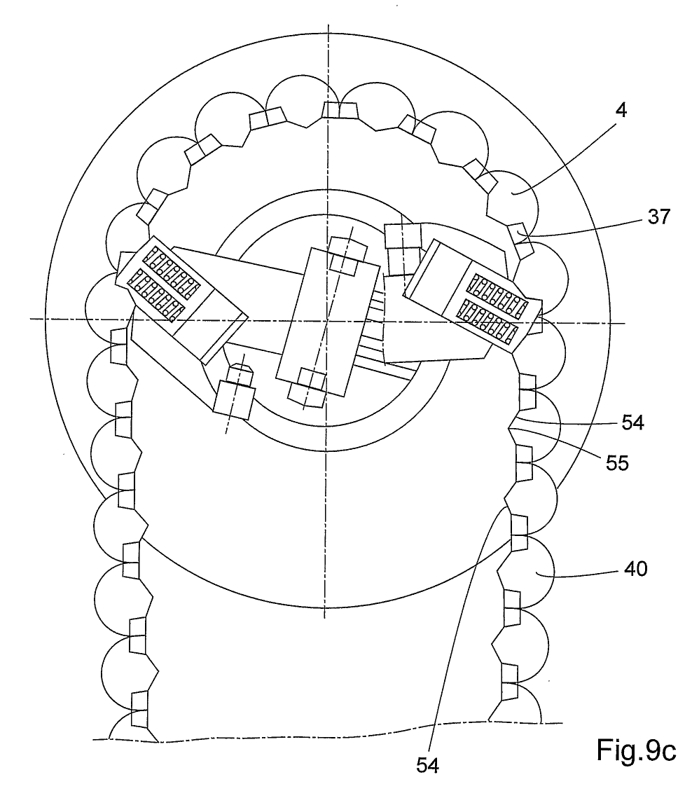

The gear tooth device 10, 50 can engage in a recess 37 of the chain 5 without influencing the driving of the chain 5, which is effected by the other gear tooth device 10, 50 connected to the primary clutch 11. Thereafter, when the tooth 32, 33 or 51 is safely engaged in the chain 5, this gear tooth device 10, 50 can start driving the chain 5 by means of alternating to the primary clutch 11, see FIGS. 8, 9a, 9b och 9c.

As an alternative, see FIG. 12, the gear tooth devices 10, 50 may both be driven at the same time by the primary clutch 11 for a period of time, corresponding to a rotational angle portion distance. This is possible if the two gear tooth devices 10, 50 are connected to their primary clutch 11 more than about half the circumference of the imaginary wheel. Thus the two gear tooth devices 10, 50 will have an overlap in the primary clutch 11 connections.

In order to achieve this, the cam axle part 20 is provided with a cam curve designed so that will make the primary clutch 11 to be engaged for more than about 180 degrees. This can also be achieved by controlling an electronic or hydraulic clutch means.

When using the second embodiment of the clutch drive the primary and secondary clutches are driven at the same speed from the input shaft 1, for example by means of a single gear unit 69 for each shaft part, see FIGS. 13 and 22. The primary clutch 66 is still a more powerful clutch than the secondary clutch 67. Preferably, the secondary clutch 67 will always be engaged and the primary clutch 68 will only be engaged for a portion of the revolution, for example about half of the revolution.

Thus the gear tooth device 10, 50 will be driven by the weaker secondary clutch 67 when the gear tooth device do not transfer torque until it has entered and engaged in the transmission chain 5 again. Then the primary clutch 66 also starts to drive the gear tooth device 10, 50 until the opposite gear tooth device 10, 50 has engaged in the chain 5 again and starts to be driven by its primary clutch 66. By that time the first gear tooth device 10, 50 is only driven by its secondary clutch 67.

A preferred embodiment of the gear tooth device 10 comprises two teeth 32, 33 provided on a stick 34, 35 each, which are connected to each other by means of a link 36, see FIG. 8. The first tooth 32, seen in the direction of movement, protrudes further out in radial direction than the second tooth 33. The first stick 34 is biased radially outwards by means of a spring (not shown) and linked to each other as mentioned above.

When the gear tooth device 10 is to engage with the chain 5 the first tooth 32 will engage in a chain recess 37 in the chain. If the first tooth 32 hits the chain 5 in between the chain recesses 37, see FIG. 8, on a preferably flat surface 38, the tooth 32 will be pushed radially inwards and due to the link 36 the second tooth 33 will protrude radially outwards and engage in a chain recess 37.

Thus, smooth and safe engaging of the gear tooth device 10 in the chain 5 is provided. The mutual distance between the two teeth 32, 33 is preferably about half of the pitch of the chain 5.

A second embodiment of the gear tooth device 50 comprises one gear tooth 51, preferably with a chamfered edge, see FIGS. 9a and 9b. In FIG. 9a a first gear tooth device 50 and its sleeve 9 is partially cut away in this view in order not to cover a second gear tooth device 50 and its sleeve 9 arranged on the opposite spline part 8 of the opposite shaft part. The first gear tooth device 50 is also shown in two positions I and III.

The gear tooth device 50 is movable lengthwise in a guide 52 and spring biased radially outwards in this guide 52 by means of at least one spring 53. The guide 52 is arranged in an angle to the spline part 8. When the tooth 51 is going to engage in the chain 5, the tooth 51 will in most cases hit a recess 37 in the chain 5 or a slope 54 leading down to a recess 37.

Between the two slopes 54 leading down to a recess 37 each an edge 55 is present. Thus, the tooth 51 will slide into a recess 37 before or after this edge 55. Although, there is a possibility that the tooth 51 hits exactly on the top of the edge 55, see position I. If this happens, the chain 5 will force the tooth 51 radially inwards against the spring force, see FIG. 9b, sliding in the guide 52. At the same time the gear tooth device 50 will move forwards together with the chain 5.

Due to this the gear tooth device 50 will move a greater distance than the chain 5. Thus it will move faster forwards than the chain 5 and the tooth 51 will move over to the slope 54 in front and slide into the recess 37 in front. The gear tooth device 50 will be pushed into the stop 31 of the other gear tooth device 50 and the spring 57 will be compressed. At the same time the secondary clutch 12 will slip. Thus an adjustment forwards is possible. Thereby the gear tooth device 50 is engaged in the chain 5 and is ready to take over the driving of the chain 5.

A third embodiment of the gear tooth device is also conceivable (not shown). It comprises one gear tooth provided at a stick. The stick is spring biased in the rotational angle direction both forwards and backwards. This is to give the gear tooth a possibility to slide into engagement in the nearest recess of the chain. Preferably the chain is provided with slopes declining into the recesses in between the recesses.

Most of the time the tooth 32, 33 or 51 comes into contact with the chain 5 in a position, which requires a slight position change, either forwards or backwards in relation to the chain direction. When the tooth 32, 33 or 51 needs to move backwards it is still driven by the weaker secondary clutch 12 and thus the clutch will slip until the gear tooth device 10, 50 engages in the chain 5. If the tooth needs to move forwards, the secondary gear tooth device 10, 50 will be pushed by the by the chain 5 and driven by the secondary clutch 12 so that the spring 57 in the stop 31 on the spline part 8 connected to the primary gear tooth device 10, 50 will be at least slightly compressed, see FIG. 8, while the secondary gear tooth device will engage in the chain recess 37 ahead.

When one of the teeth 32, 33 or the tooth 51 has engaged in the chain 5 the driving of the gear tooth device 10, 50 may change from the secondary clutch 12 to the primary clutch 11 and thus drive the chain 5. At the same time the other gear tooth device 10, 50 that had driven the chain 5 by means of the primary clutch 11 may change over to be driven by the secondary clutch 12 and disengage from the chain 5 and begin to run faster than the now chain-driving gear tooth device 10, 50, due to the fact that it is driven by the secondary clutch 12.

In a preferred embodiment, the chain 5 is preferably made up by a number of bolts connected by means of links 40 with side portions 41, see FIG. 2, in between the bolts recesses 37 are made, and as mentioned above, the bolts are preferably made flat at the inside, thus making up flat portions 38 in between the chain recesses 37 when gear tooth devices 10 of the preferred embodiment are used. The side portions 41 have inclined outer sides 42 that correspond to the inclination of the conical plates 24. Of course the chain 5 may be designed in other ways, too, but preferably having some kind of means guiding a tooth 32, 33 that is to engage in the chain 5.

According to the second and third embodiment of the gear tooth device 50, the chain 5 is provided with slopes 54 declining into the recesses 37 in between the recesses 37 instead of flat surfaces 38 as when used together with the gear tooth devices 10 of the preferred embodiment.

In FIG. 9c another embodiment of the chain 5 is shown. Here the recesses 37 are provided in between the links 40 and the slopes 54 and the edge 55 are arranged at the links 40.

In the embodiment where the gear tooth device partially cooperate to drive the chain 5 via the primary clutch 11 the chain 5 may preferably surround more than 180 degrees of the imaginary gear wheel, for example up to 320 degrees, see FIG. 12. This is achieved by means of at least one, in the shown embodiment two, straining pulleys 63. If only one straining pulley is used it has preferably a much larger diameter (not shown) than the two straining pulleys 63 shown in FIG. 12.

In this embodiment the transmission chain 5 is preferably provided with bolts 64 with a circular cross section and links 40 with a slightly inwards bent outside so that the chain 5 will smoothly follow the circumference of the straining pulley/-s 63. In this embodiment the links 40 is provided with inwards protruding portions making up the slopes 54 and the edge 55, whereby the chain recesses 37 are provided in between the protruding portions of the links 40.

In a first embodiment of the CVT according to the present invention the output side comprises a second gearbox shaft 6. It will be driven by the chain 5 and a first gear tooth device 10, 50 will be engaged in the chain 5 and transfer the power from the chain 5 via the gear tooth device 10, 50 connected to the primary clutch 11 and further to the output shaft 2. The second gearbox shaft 6 works in the corresponding way as the first gearbox shaft 4 and the gear tooth devices 10, 50 will alternate in the same way as described above to transfer the power from the chain 5 to the output shaft 2.

The gear-changing shaft 3, see FIG. 1, are provided with threads 27 for both gearbox shafts 4, 6 but in opposite directions for the two shafts 4, 6. Thus the arms 26 connected to each shaft 4, 6 will synchronically move when the gear-changing shaft 3 is turned.

In this way the conical plates 24 will move away from each other and the corresponding gear tooth devices 10, 50 will be retracted in any of the described ways making up a imaginary gear wheel with a decreasing pitch diameter at one of the shafts while the conical plates 24 will move towards each other and the corresponding gear tooth devices 10, 50 will protrude in any of the described ways making up a imaginary gear wheel with an increasing pitch diameter at the other shaft. In this way the chain 5 will always be stretched.

In a second embodiment of the CVT according to the present invention the output side comprises a second gearbox shaft 6, see FIG. 22. It will be driven by the chain 5 and a first gear tooth device 10, 50 will be engaged in the chain 5 and transfer the power from the chain 5 via the gear tooth device 10, 50 connected to the primary clutch 66 and further to the output shaft 2. The second gearbox shaft 6 works in the corresponding way as the first gearbox shaft 4 and the gear tooth devices 10, 50 will always drive the secondary clutch 67 and for about half of the revolution also the primary clutch 66.

In a third embodiment of the CVT according to the present invention the output side comprises a gear wheel 7, see FIGS. 10 and 11. This is possible if the pitch diameter is matched with the chain pitch so that the teeth 43 of the gear wheel 7 will engage in the chain 5 without any adjustment means, for ensample if the diameter is equally dividable.

In order to keep the chain 5 stretched independent of the “diameter” of the two gear tooth devices 10, 50 of the gearbox shaft 4, the gear wheel is movably mounted in a slide 44. The slide 44 is movable along at least one guide 45, preferably two, and arranged one on each side of the gear wheel 7, see positions I and II in FIGS. 10 and 11. The slide 44 is connected via a nut 48, fixedly attached to the slide 44, a feed gear shaft 46 and an angle gear device 47 to the gear-changing shaft 3. Thus the turning, i.e. the changing of gears, of the gear-changing shaft 3 will be transferred and converted to a turning of the feed gear shaft 46 by means of the angle gear device 47. Preferably the gear-changing shaft 3 and the feed gear shaft 46 are perpendicularly arranged.

The feed gear shaft 46 has preferably a progressive thread 49 matching the need of movement with the change of diameter in the gearbox shaft 4 so that the chain 5 will be well-balanced and sufficiently stretched. The nut 48 has a cylindrical recess with a short inner thread (not shown) that will be able to follow the progressive outer thread 49 of the feed gear shaft 46. The rotation of the gear wheel 7 is transferred to an output shaft 2 either directly or in any conventional, suitable way (not shown).

Of course it is conceivable to use the gear wheel for the input side and the gearbox shaft 4 for the output side, if so desired.

A fourth embodiment of the CVT according to the invention is possible, too, based on the first and second embodiment. When a pitch diameter matching the chain pitch is present at one of the gearbox shafts 4, 6 so that the distance between the two gear tooth devices 10, 50 is 180 degrees, the gearbox shaft in question may run without any clutch changes. The primary clutch 11 is constantly engaged by means of retracting the pin 18 so that the pin 18 will not interact with the cam axle part 20. In this way the mechanical wear of the parts will decrease during running of the vehicle at the same speed, for example during motorway driving. This feature of the third embodiment can be controlled by means of a control program, for example (not shown).

Reverse gear may be applied on the output shaft 2 in a conventional way.

The present invention of a gear assembly and continuously variable transmissions using such a gear assembly are not restricted to the shown and described embodiments but various amendments, changes and substitutions of parts are conceivable as well as further developments within the scope of the following claims.

1. A gear assembly making up an imaginary gear wheel with variable pitch diameter, suitable for a continuously variable transmission, comprising two gear tooth devices, the two gear tooth devices being radially movable.

2. The gear assembly according to claim 1, wherein the two gear tooth devices are directed about 180 degrees from each other within a range up to +/−20 degrees.

3. The gear assembly according to claim 1, wherein the gear tooth devices are movably connected in radial direction at a radially arranged part each, the parts being arranged on opposite, facing ends of two aligned shaft parts of a gearbox shaft.

4. The gear assembly according to claim 3, wherein two conical plates are provided, one at each opposite end of the two aligned parts of the gearbox shaft in order to support a transmission chain at its sides.

5. The gear assembly according to claim 4, wherein the conical plates are synchronically movable towards and from each other by means of an arm each, connected to a gear-changing shaft by means of opposite directed threads provided on the gear-changing shaft.

6. The gear assembly according to claim 5, wherein the gear tooth devices are synchronically movable radially outwards by means of movement of the conical plates towards each other.

7. The gear assembly according to claim 5, wherein the gear tooth devices are synchronically movable radially inwards by means of a chain arranged in the gear tooth device and via links connected to the arms, which are synchronically movable by means of the gear-changing shaft.

8. The gear assembly according to claim 5, wherein the gear tooth devices are synchronically movable radially inwards and outwards along the radially arranged parts by means of at least one lever each, arranged at the gear tooth device and at the shaft part, the lever being connected to the conical plates, which in turn are connected to the gear-changing shaft via the arms and thus the levers are movable synchronically with the conical plates.

9. The gear assembly according to claim 1, wherein the two gear tooth devices are substantially alternately in engagement in a transmission chain.

10. The gear assembly according to claim 1, wherein each gear tooth device is driven at least a portion of the revolution by means of a primary clutch and at least a portion of the revolution by means of a secondary clutch.

11. The gear assembly according to claim 1, wherein each gear tooth device is driven at least a portion of the revolution by means of a primary clutch and always driven by means of a secondary clutch.

12. The gear assembly according to claim 1, wherein the clutches drives the shaft part on which the gear tooth device is arranged.

13. The gear assembly according to claim 10, wherein a rotating cam cooperates with a pin in order to control the primary and secondary clutches and its springs.

14. The gear assembly according to claim 1, wherein at least a fixed cam cooperates with at least one cam follower in order to control the primary and secondary clutches and its springs.

15. The gear assembly according to claim 1, wherein the gear tooth device comprises two gear teeth provided on a stick each, which sticks are connected to each other by means of a link.

16. The gear assembly according to claim 15, wherein a first gear tooth protrudes further out in the radial direction than the second tooth.

17. The gear assembly according to claim 15, wherein at least the first gear tooth stick is spring biased radially outwards, and thus pushable radially inwards while the second gear tooth and its stick then is movable radially outwards due to the link.

18. The gear assembly according to claim 1, wherein the gear tooth device comprises one gear tooth, which gear tooth device is movable lengthwise in a guide and spring biased radially outwards in this guide by means of at least one spring (53).

19. The gear assembly according to claim 1, wherein the gear tooth device comprises one gear tooth and that the gear tooth device is spring biased and movable in the rotational angle direction both forwards and backwards.

20. A continuously variable transmission, comprising an input shaft, an output shaft connected to the input shaft via a first, gearbox shaft and a second gearbox shaft by means of a transmission chain, wherein that the first and second gearbox shaft each having a gear assembly of claim 1 whereby the first gearbox shaft is driven by the input shaft, the second gearbox shaft is driven by the first gearbox shaft via the transmission chain, and the output shaft is driven by the second gearbox shaft.

21. The continuously variable transmission according to claim 20, wherein a gear-changing shaft is connected via arms to the first gear box shaft and the second gear box shaft for synchronized movement of the two gear tooth devices per gear box shaft in order to decrease the pitch diameter at the first gear box shaft at the same time as the pitch diameter of the second gear box shaft increases; or vice versa.

22. The continuously variable transmission, comprising an input shaft, an output shaft connected to the input shaft via a gearbox shaft and a gear wheel by means of a transmission chain, wherein the gearbox shaft including a gear assembly according claim 1, whereby the gearbox shaft is driven by the input shaft, the gear wheel is driven by the first gearbox shaft via the transmission chain, and the output shaft is driven by the gear wheel; or vice versa.

23. The continuously variable transmission according to claim 22, wherein the gear wheel is movably mounted in order to keep the transmission chain stretched independent of the pitch diameter of the imaginary gear wheel made up by the two gear tooth devices in the gearbox shaft.

24. The continuously variable transmission according to claim 22, wherein a gear-changing shaft is connected via arms to the gear box shaft for synchronized movement of the two gear tooth devices and to the gear wheel for synchronized movement of the gear wheel in order to decrease the pitch diameter at the gear box shaft at the same time as the distance between the gear box shaft and the gear wheel increases; or vice versa.
